(19) United States
(12) Patent Application Publication
(10) Pub. No.: US 2008/0118805 A1
(43) Pub. Date: May 22, 2008

(54) MEMBRANE-ELECTRODE ASSEMBLY FOR FUEL CELL, METHOD OF PREPARING SAME AND FUEL CELL SYSTEM INCLUDING SAME

(76) Inventors: Sang-Il Han, Yongin-si (KR); In-Hyuk Son, Yongin-si (KR)

Correspondence Address: CHRISTIE, PARKER & HALE, LLP, PO BOX 7068, PASADENA, CA, 91109-7068, US

(21) Appl. No.: 11/875,775

(22) Filed: Oct. 19, 2007

(30) Foreign Application Priority Data
Nov. 20, 2006 (KR) 10-2006-0114604

(51) Int. Cl. H01M 8/10; B05D 5/12

(52) U.S. Cl. 429/30; 427/115

(57) ABSTRACT

A fuel cell system including at least one electricity generating element, a fuel supplier, and an oxidant supplier. The electricity generating element includes a membrane-electrode assembly and a separator arranged a side of the membrane-electrode assembly. The membrane-electrode assembly has excellent reactant diffusion and minimizes (or reduces) mass transfer resistance, thereby producing a relatively high power and/or a highly efficient fuel cell system.

### CROSS-REFERENCE TO RELATED APPLICATION

This application claims priority to and the benefit of Korean Patent Application No. 10-2006-0114604 filed in the Korean Intellectual Property Office on Nov. 20, 2006, the entire content of which is incorporated herein by reference.

### BACKGROUND OF THE INVENTION

1. Field of the Invention

The present invention relates to a membrane-electrode assembly for a fuel cell, a method of manufacturing the same, and a fuel cell system including the same.

2. Description of the Related Art

A fuel cell is a power generation system which produces electrical energy through an electrochemical redox reaction of an oxidant and hydrogen in a hydrocarbon-based material such as methanol, ethanol, or natural gas. Such a fuel cell is a clean energy alternative that can replace fossil fuels. A typical fuel cell includes a stack of unit cells which produces various ranges of power.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

The polymer electrolyte fuel cell has relatively high energy density, but requires extra handling capabilities for processing hydrogen gas and related processing accessories, such as fuel reforming processors for reforming methane, methanol, or natural gas, and the like in order to produce hydrogen as the fuel gas.

In contrast, a direct oxidation fuel cell has lower energy density than that of the polymer electrolyte fuel cell and does not need additional fuel reforming processors.

### SUMMARY OF THE INVENTION

Aspects of embodiments of the present invention are directed toward a membrane-electrode assembly for a fuel cell that provides relatively high power and high efficiency due to better reactant diffusion, a method of manufacturing the same, and/or a fuel cell system including the same.

Another aspect of an embodiment of the present invention is directed toward a membrane-electrode assembly for a fuel cell that may easily diffuse reactants.

Another aspect of an embodiment of the present invention is directed toward a method of manufacturing the membrane-electrode assembly.

Another aspect of an embodiment of the present invention is directed toward a fuel cell system having high power and high efficiency.

According to an embodiment of the present invention, there is provided a membrane-electrode assembly for a fuel cell. The membrane-electrode assembly includes: a cathode; an anode facing the cathode; and a polymer electrolyte membrane between the cathode and the anode. Here, at least one of the anode or the cathode includes a plurality of channels disposed therein.

In one embodiment, the channels of the at least one of the anode or the cathode extend in a reactant injection flow direction (e.g., a fuel injection flow direction) to ease diffusion of a reactant.

In one embodiment, an average diameter of the channels ranges from about 10 nm to about 500 nm.

According to another embodiment of the present invention, there is provided a method of manufacturing a membrane-electrode assembly for a fuel cell. The method includes: applying a material for reducing surface adherence on a releasing film including a plurality of first channels therein to form a surface adherence suppressing layer; positioning the surface adherence suppressing layer with the releasing film on a plate for air suction; applying a catalyst composition on the surface adherence suppressing layer while applying suction to form a catalyst layer comprising a plurality of second channels corresponding to the first channels; positioning the releasing film with the catalyst layer on a polymer electrolyte membrane and transferring the catalyst layer to the polymer electrolyte membrane by hot-pressing; and removing the releasing film with the surface adherence suppressing layer from the catalyst layer transferred to the polymer electrolyte membrane.

According to another embodiment of the present invention, there is provided a fuel cell system. The fuel system includes an electricity generating element, a fuel supplier, and an oxidant supplier. The electricity generating element is adopted to generate electricity through oxidation of a fuel and reduction of an oxidant and includes a separator and a membrane-electrode assembly including a cathode, an anode facing the cathode, and a polymer electrolyte membrane between the cathode and the anode, wherein at least one of the anode or the cathode includes a plurality of channels disposed therein. The separator is on a least one side of the membrane-electrode assembly. The fuel supplier is for supplying a fuel to the electricity generating element; and the oxidant supplier is for supplying an oxidant to the electricity generating element.

### BRIEF DESCRIPTION OF THE DRAWINGS

FIG. 1 schematically shows channels in a membrane-electrode assembly according to one embodiment of the present invention;

FIG. 2 schematically shows a process of forming channels in a membrane-electrode assembly according to one embodiment of the present invention;

FIG. 3 schematically shows a fuel cell system according to one embodiment of the present invention;

FIGS. 4 and 5 show a power characteristic of a fuel cell according to Example 1; and

FIGS. 6 and 7 show a power characteristic of a fuel cell according to Comparative Example 1.

### DETAILED DESCRIPTION

A membrane-electrode assembly according to one embodiment of the present invention includes a cathode and an anode facing each other, and a polymer electrolyte membrane interposed therebetween. The anode and cathode include channels disposed therein.

When reactants, such as a fuel and an oxidant are injected into the catalyst of the electrodes, the channels disposed inside the anode and the cathode, and, particularly, the channel extending in the fuel injection flow direction facilitate the diffusion of the reactants, thereby decreasing mass transfer resistance.

The channels may have an average diameter ranging from about 10 nm to about 500 nm (or from 10 nm to 500 nm). When the channels have an average diameter of less than 10 nm, they may not adequately release water produced during the reaction and disperse the fuel. On the other hand, when the channels have an average diameter of more than 500 nm, the fuel may directly cross over the polymer electrolyte membrane. In addition, an electrode binder may exist in a higher concentration around the channel than at other places.

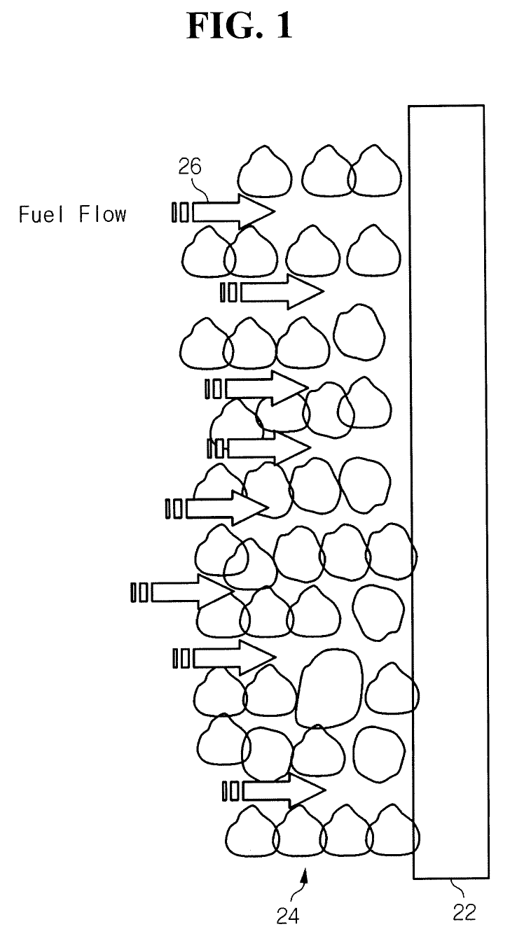

FIG. 1 schematically shows a polymer electrolyte membrane 22 and an anode 24 disposed on the polymer electrolyte membrane 22 in a membrane-electrode assembly for a fuel cell according to an embodiment of the present invention. FIG. 1 shows only an anode 24 to illustrate a fuel flow through a channel 26 formed in an electrode, and a cathode has the same (or substantially the same) structure at the other side of the polymer electrolyte membrane 22.

As shown in FIG. 1, since a channel 26 is formed inside an electrode, fuel may easily flow into a catalyst layer of the electrode therethrough.

The anode and cathode each includes an electrode substrate and a catalyst layer.

The catalyst layer includes a binder and a catalyst.

The catalyst may include any suitable catalyst that may be useful in a fuel cell reaction. In one embodiment, the catalyst includes a platinum-based catalyst. In one embodiment, the platinum-based catalyst includes a material selected from the group consisting of platinum, ruthenium, osmium, a platinum-ruthenium alloy, a platinum-osmium alloy, a platinum-palladium alloy, a platinum-M alloy, and combinations thereof, where M is a transition metal selected from the group consisting of Ga, Ti, V, Cr, Mn, Fe, Co, Ni, Cu, Zn, Sn, Mo, W, Rh, Ru, and combinations thereof. Representative examples of the catalysts include a material selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/RuN, Pt/Fe/Co, Pt/Ru/Rh/Ni, Pt/Ru/Sn/W, and combinations thereof.

The catalysts may be supported on a carbon supporter or not supported as a black type. Suitable supporters include carbon-based materials such as graphite, denka black, ketjen black, acetylene black, carbon nanotubes, carbon nanofiber, carbon nanowire, carbon nanoballs, activated carbon, and so on, or inorganic material particulates such as alumina, silica, zirconia, titania, and so on.

The binder resin may be a proton conductive polymer resin having a cation exchange group selected from the group consisting of a sulfonic acid group, a carboxylic acid group, a phosphoric acid group, a phosphonic acid group, and derivatives thereof at its side chain. Non-limiting examples of the polymer include a proton conductive polymer selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

In one embodiment, the proton conductive polymer is composed of a material selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly(2,5-benzimidazole), and combinations thereof.

The H component of the proton conductive group at the proton conductive polymer side chain may be substituted by Na, K, Li, Cs, or tetrabutylammonium. When the H in the ionic exchange group of the terminal end of the proton-conductive polymer side is substituted with Na or tetrabutylammonium, NaOH or tetrabutylammonium hydroxide may be used, respectively. When the H is substituted with K, Li, or Cs, suitable compounds, such as KOH, or LiOH, may be used.

The binder resin may include one type of binder or be used in combination with other binders. The binder may also be used with other non-conductive polymers to improve adherence with the polymer electrolyte membrane. The binder resins may be used in a controlled amount as needed.

Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol, and combinations thereof.

The electrode substrate is plays a role of supporting an electrode, and also of spreading the fuel and the oxidant to a catalyst layer to help the fuel and oxidant to reach the catalyst layer easier. As for the electrode substrate, a conductive substrate is used, for example carbon paper, carbon cloth, carbon felt, or metal cloth (a porous film including a metal cloth fiber or a metalized polymer fiber), etc.

The electrode substrate can further be treated with a fluorine-based resin to be water-repellent, to combat water generated during fuel cell operation and to prevent deterioration of the reactant diffusion efficiency. The fluorine-based resin includes polytetrafluoroethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, or copolymers thereof.

A micro-porous layer (MPL) may be added between the electrode substrate and catalyst layer to increase reactant diffusion effects. In general, the MPL may include, but is not limited to, a small-sized conductive powder such as a carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The MPL is formed by coating a composition including a conductive powder, a binder resin, and a solvent onto a conductive substrate. The binder resin may include, but is not limited to, polytetrafluoroethylene (PTFE), polyvinylidene fluoride, polyhexafluoropropylene, polyperfluoroalkylvinylether, polyperfluorosulfonylfluoride, alkoxyvinyl ether, polyvinylalcohol, cellulose acetate, and copolymers thereof. The solvent may include, but is not limited to, an alcohol such as ethanol, isopropyl alcohol, ethyl alcohol, n-propyl alcohol, or butyl alcohol; water; dimethylacetamide (DMAc); dimethyl formamide; dimethyl sulfoxide (DMSO); N-methylpyrrolidone; or tetrahydrofuran. The coating method may include, but is not limited to, screen printing, spray coating, doctor blade methods, gravure coating, dip coating, silk screening, painting, and so on, depending on the viscosity of the composition.

The polymer electrolyte membrane functions as an ion-exchange member to transfer protons generated from an anode catalyst layer to the cathode catalyst layer. The polymer electrolyte membrane of the membrane-electrode assembly may generally include a proton conductive polymer resin. The proton conductive polymer resin may be a polymer resin having a cation exchange group selected from the group consisting of a sulfonic acid group, a carboxylic acid group, a phosphoric acid group, a phosphonic acid group, and derivatives thereof, at its side chain.

Non-limiting examples of the polymer resin include a material selected from the group consisting of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In one embodiment, the proton conductive polymer is a material selected from the group consisting of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly(2,5-benzimidazole), and combinations thereof.

The H in the proton conductive group of the proton conductive polymer may be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used, respectively. When the H is substituted with K, Li, or Cs, suitable hydroxide compounds, such as KOH, LiOH, or other suitable compounds may be used.

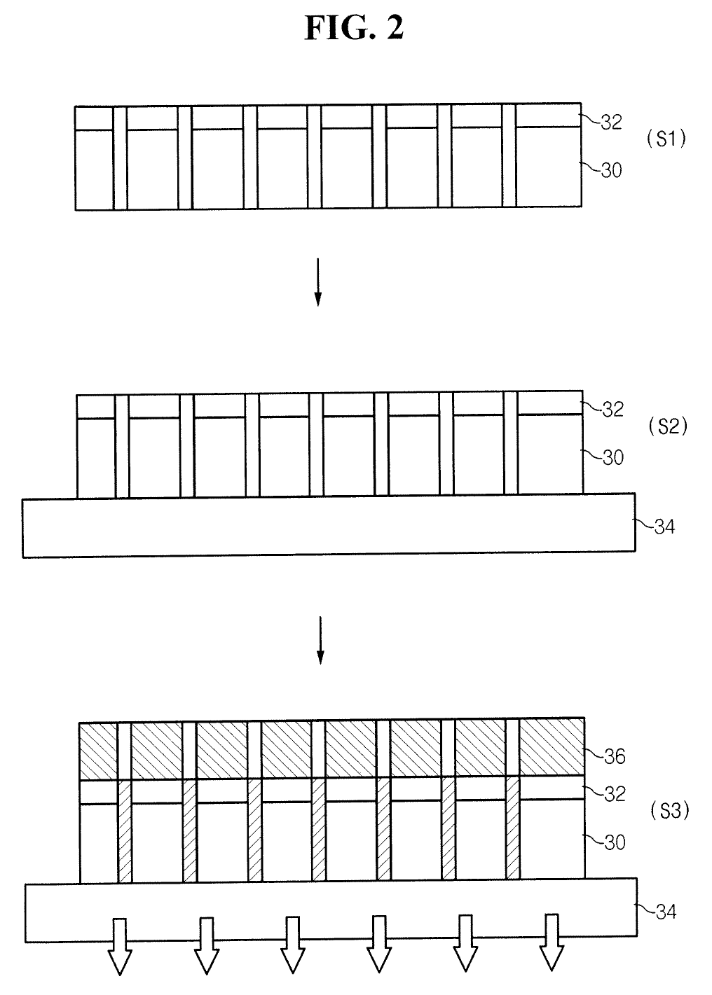

In one embodiment, a method of forming a channel inside an electrode is disclosed and illustrated in more detail in accordance to FIG. 2.

First, a material being capable of minimizing (or reducing) surface adherence is coated on a releasing film 30 with channels to form a surface adherence suppressing layer 32 (S1 in FIG. 2) thereon.

The releasing film includes a polymer that does not react with a catalyst. Examples of the polymer include polytetrafluoroethylene, polyvinylidene fluoride, polyethylene, polypropylene, polyethylene terephthalate, or polyester.

The material being capable of minimizing (or reducing) surface adherence includes a material selected from the group consisting of glycerine, polyethylene glycol, sorbitol, polytetramethylene glycol (PTMG), low molecular weight siloxane, polypropyleneglycol, and combinations thereof. When the material capable of minimizing (or reducing) surface adherence has a degree (that may be predetermined) of viscosity during the coating, it does not need additional solvents. If needed, however, the material may be prepared as a composition including a solvent for better coating. The solvent may include water, dihydric alcohol having C2 to C4, or dimethylacetate. The composition has a concentration ranging from about 5 wt % to about 30 wt % (or from 5 wt % to 30 wt %). When the composition has a concentration of less then 5 wt %, the desired effects may not be realized. On the other hand, when it has a concentration of more than 30 wt %, the viscosity of the composition may be too high to be easily coated on the surface of the releasing film.

Next, the releasing film 30 formed with the surface adherence suppressing layer 32 is positioned on a plate 34 that can absorb air (S2 in FIG. 2).

Then, a catalyst composition is coated while air is being absorbed (an arrow inside the plate in FIG. 2), thereby forming a catalyst layer 36 (S3 in FIG. 2). Since the catalyst composition is coated while the air is being absorbed, the catalyst layer 36 is formed to have channels as the solvent in the catalyst composition dried off. Herein, air is absorbed with a pressure ranging from about 0.5 atm to about 3 atm (or 0.5 atm to 3 atm.) When air is absorbed at a pressure of less than 0.5 atm, the absorption pressure is too weak to form proper channels within the catalyst layer. On the other hand, when air is absorbed at a pressure of more than 3 atm, too much catalyst may be lost unnecessarily due to high air absorption.

Herein, a binder included in a catalyst composition may exist around the channels at a higher concentration than at other places, while a catalyst layer is formed to have the channels.

In one embodiment, the catalyst composition includes a catalyst, a binder, and a solvent, wherein the catalyst and the binder are the same (or substantially the same) as the catalyst and binder mentioned above.

Examples of the solvent include water, alcohols such as methanol, ethanol, isopropyl alcohol, N-methylpyrrolidone, dimethylacetamide, dimethylsulfoxide, tetrahydrofuran, acetone, or mixtures thereof.

Next, a polymer electrolyte membrane is positioned on the catalyst layer formed on the releasing film 30. They are then hot-pressed together to transfer the catalyst layer 36 into the polymer electrolyte membrane.

The hot-pressing process may be performed at a temperature ranging from about 100° C. to about 135° C. (or 100° C. to 135° C.) with a pressure ranging from about 1000 psi to about 1500 psi (or 1000 psi to 1500 psi.) When hot-pressing is performed at a temperature of less than 100° C., a hydrogen ion conductive polymer in the polymer electrolyte membrane and the catalyst layer may not be properly bound to one another. On the other hand, when hot-pressing is performed at a temperature of more than 135° C., it may cause thermal/physical decomposition. In other words, an ion cluster area may be too shrunken or deformed to expand again due to moisture loss, thereby causing extremely high initial resistance.

However, when H of a hydrogen ion conductive group in the binder of the composition for the catalyst layer and a hydrogen ion conductive polymer of a polymer electrolyte membrane is substituted with Na, K, Li, Cs, or tetrabutylammonium, thermal stability can be realized Accordingly, when hot-pressing is performed at 135° C. or more when using these alternative substitutions, the ionomer binder and a hydrogen ion conductive polymer may not be deteriorated, and the life-cycle of a fuel cell is not going to be decreased. In addition, when H is substituted with Na, K, Li, Cs, or tetrabutylammonium, the catalyst layer may be acid-treated and may thereby be converted into a proton (H⁺)-form polymer electrolyte membrane.

Furthermore, the pressure in the hot-pressing process should be regulated to optimize electrical conductivity, ion conductivity, and reactant movement (mass transport). When the pressure is higher than 1500 psi, the catalyst layer may be so compacted that fluid resistance will increase. Therefore the flows of fuel and oxidant may experience larger diffusion resistances when they flow into and are released from the electrodes. On the other hand, when the pressure is lower than 1000 psi, the membrane may be easily separated from the electrodes, which can also raise electrical and ion-conductive resistances.

When the hot-pressing is complete, the releasing film is removed from the polymer electrolyte membrane with the newly transferred catalyst layer. Accordingly, the catalyst layer is adhered to one side of the polymer electrolyte membrane. The same (or substantially the same) process is then performed at the other side of the polymer electrolyte membrane, forming a membrane-electrode assembly.

Next, when H of a hydrogen ion conductive group is substituted with Na, K, Li, Cs, or tetrabutylammonium in the ionomer binder and the polymer electrolyte membrane, a membrane-electrode assembly including the ionomer binder and the polymer electrolyte membrane may be acid-treated to substitute a proton (H⁺)-form for Na, K, Li, Cs, or tetrabutylammonium. The acid-treatment is performed by treating the membrane-electrode assembly at a temperature ranging from about 80° C. to 100° C. (or 80° C. to 100° C. ) with acid, and then washing it with water. The acid may include sulfuric acid, but is not limited thereto. Generally, it may include a sulfuric acid aqueous solution at about a 1M concentration.

The membrane-electrode assembly may be applied to a polymer electrolyte membrane fuel cell (PEMFC) or a direct oxidation fuel cell (DOFC). In one embodiment, reactant diffusion efficiency may be maximized when the membrane-electrode assembly is used in a direct oxidation fuel cell.

In the fuel cell system including the membrane-electrode assembly, the electricity generating element generates electricity through oxidation of a fuel and reduction of an oxidant. The electricity generating element includes the membrane-electrode assembly that includes a cathode and an anode facing each other, and a polymer electrolyte membrane interposed between the cathode and the anode.

The fuel supplier plays a role of supplying the electricity generating element with a fuel. The fuel includes liquid or gaseous hydrogen, or a hydrocarbon-based fuel. In a DOFC system, a hydrocarbon fuel is appropriate. The hydrocarbon fuel includes methanol, ethanol, propanol, butanol, or natural gas.

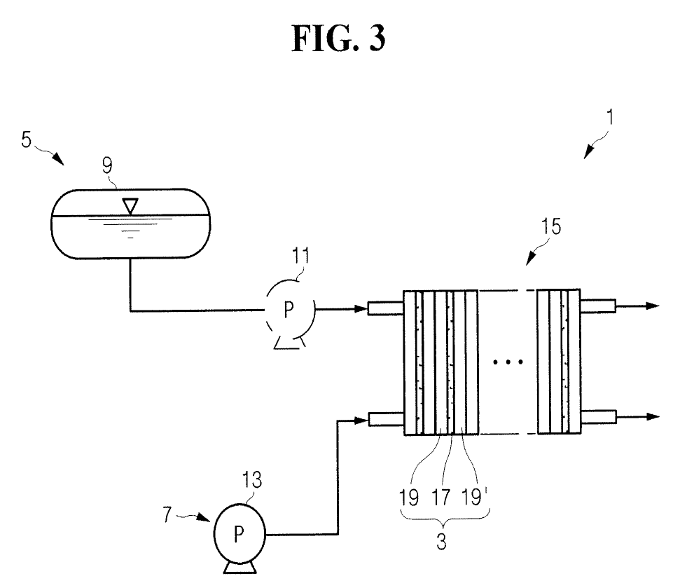

FIG. 3 shows a schematic structure of a fuel cell system that will be described in more detail hereafter. FIG. 3 illustrates a fuel cell system wherein the fuel and the oxidant are provided to the electricity generating element via their respective pumps, but the present invention is not limited to such structures. The fuel cell system of the present invention alternatively can include a structure wherein the fuel and the oxidant are provided in a diffusion manner.

A fuel cell system 1 includes one or more electricity generating elements 3 that generate electrical energy through an electrochemical reaction of the fuel and the oxidant, a fuel supplier 5 for supplying the fuel to the electricity generating elements 3, and an oxidant supplier 7 for supplying the oxidant to the electricity generating elements 3.

In addition, the fuel supplier 5 is equipped with a tank 9 that stores the fuel, and a pump 11 that is connected therewith. The fuel pump 11 supplies the fuel stored in the tank 9 with a pumping power (that may be predetermined).

The oxidant supplier 7, which supplies the electricity generating element 3 with an oxidant, is equipped with at least one pump 13 for supplying the oxidant with a pumping power (that may be predetermined).

The electricity generating element 3 includes a membrane-electrode assembly 17 that oxidizes hydrogen or the fuel and reduces the oxidant, and separators 19 and 19′ that are respectively positioned at opposite sides of the membrane-electrode assembly and supply hydrogen or the fuel, and the oxidant, respectively. The electricity generating elements 3 are stacked adjacent to one another to form a stack 15.

The following examples illustrate the present invention in more detail. However, it is understood that the present invention is not limited by these examples.

### EXAMPLE 1

A commercially-available NAFION 115 membrane (with a thickness of 125 μm) was treated in a 3% hydrogen peroxide solution and a 0.5M sulfuric acid aqueous solution at 90° C. for 2 hours. It was then washed with deionized water at 100° C. for one hour, to produce an H⁺-type NAFION 115 polymer electrolyte membrane (with a thickness of thickness: 120-135 μm)

Then, 4.5 g of a 30 wt % NAFION (Dupont Co.) aqueous dispersion solution and 12 wt % of sorbitol were added to 3.0 g of Pt black (HISPEC1000, Johnson Mafthey Co.) and Pt/Ru black (HISPEC 6000, Johnson Matthey Co.) catalysts in a dropwise fashion. The mixture is then mechanically agitated to produce the cathode and anode catalyst layers.

Next, a material with a molecular weight of 600 that may minimize (or reduce) polyethylene glycol surface adherence was coated on a porous polypropylene film, to form a surface adherence suppressing layer (e.g., the surface adherence suppressing layer 32 of FIG. 2).

The porous polypropylene film with the surface adherence suppressing layer was positioned on a plate that may absorb air. While air was being absorbed through the plate with a pressure of 1 atm, the composition for cathode and anode catalyst layers was directly coated on the porous polypropylene film via a screening method, thereby forming cathode and anode catalyst layers. Herein, each of the catalyst layers had an area of 3.2×3.2 cm², in which each catalyst was loaded in an amount of 3 mg/cm² therein. In addition, air was absorbed with a pressure of 1 atm during the coating to make pores and thereby form channels with an average diameter of 500 nm.

Next, the resulting H⁺-type NAFION 115 polymer electrolyte membrane was hot-pressed at 135° C. with a pressure of 1500 psi to respectively transfer each of the cathode and anode catalyst layers, thereby forming the cathode and anode catalyst layers at both side of the polymer electrolyte membrane, respectively. Herein, the channels were extended in an injection flow direction.

Then, commercially-available electrode substrates (an uncatalyzed gas diffusion electrode, SGL Carbon 31BC) were physically adhered to both sides of the polymer electrolyte membrane with the catalyst layers, respectively. The product was inserted between two sheets of gaskets and also, between two separators with a shape (that may be predetermined) having flow channels and cooling channels, and thereafter compressed between copper end plates, to thereby form a 25 cm² unit cell.

### EXAMPLE 2

A 25 cm² unit cell was fabricated according to the same (or substantially the same) method as in Example 1, except that hot-pressing was performed at 100° C. with a pressure of 1000 psi.

### EXAMPLE 3

A 25 cm² unit cell was fabricated according to the same (or substantially the same) method as in Example 1, except for using glycerine instead of polyethylene glycol.

### EXAMPLE 4

A 25 cm² unit cell was fabricated according to the same (or substantially the same) method as in Example 1, except for using sorbitol instead of polyethylene glycol.

### EXAMPLE 5

A 25 cm² unit cell was fabricated according to the same (or substantially the same) method as in Example 1, except for using siloxane instead of polyethylene glycol.

### COMPARATIVE EXAMPLE 1

A commercially-available NAFION 115 membrane (with thickness of about 125 μm) was respectively treated in 3% hydrogen peroxide and a 0.5M sulfuric acid aqueous solution at 90° C. for 2 hours. Then, it was washed with deionized water at 100° C. for 1 hour, thereby preparing an H⁺-type NAFION 115 membrane (thickness ranging from 120 to 135 μm).

Then, 4.5 g of a 30 wt % NAFION (Dupont Co.) aqueous dispersion solution was dropwisely added to 3.0 g of Pt black (HISPEC 1000, Johnson Mafthey Co.) and Pt/Ru black (HISPEC 6000, Johnson Matthey Co.) catalysts, and then mechanically agitated together, thereby forming a composition for cathode and anode catalyst layers.

The composition for cathode and anode catalyst layers was respectively coated on a polytetrafluoroethylene releasing film in a screening method. Herein, each of the catalyst layers had an area of 3.2×3.2 cm², in which each catalyst was loaded in an amount of 3 mg/cm². Then, the cathode and anode catalyst layers were respectively transferred onto sides of the acquired H⁺-type NAFION 115 polymer electrolyte membrane at 135° C. with a pressure of 1 atm, thereby forming the cathode catalyst layer and the anode catalyst layer at respective sides of the polymer electrolyte membrane.

Next, a commercially-available electrode substrate (uncatalyzed gas diffusion electrode, SGL Carbon 31BC) was adhered to both sides of the polymer electrolyte membrane having catalyst layers, respectively. The resulted product was inserted between two sheets of gaskets and also, between two separators with a shape (or predetermined shape), and having gas flow channels and cooling channels, and compressed between copper end plates, to thereby prepare a 25 cm² unit cell.

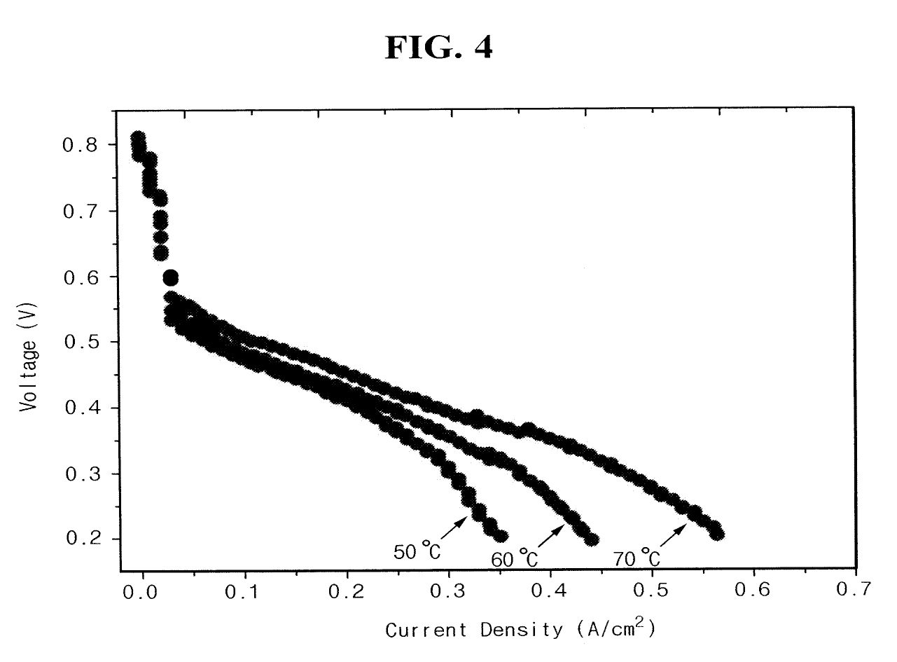

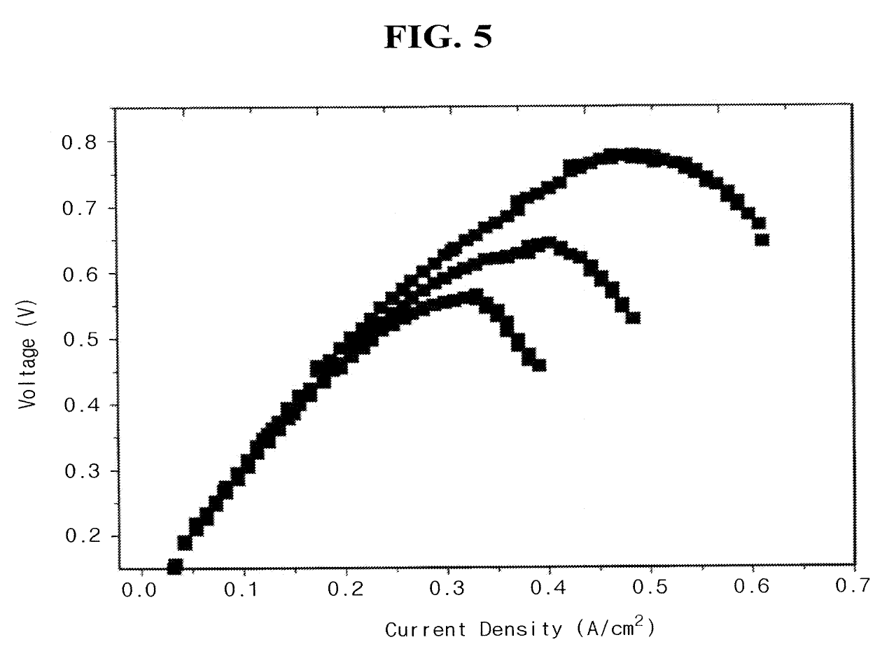

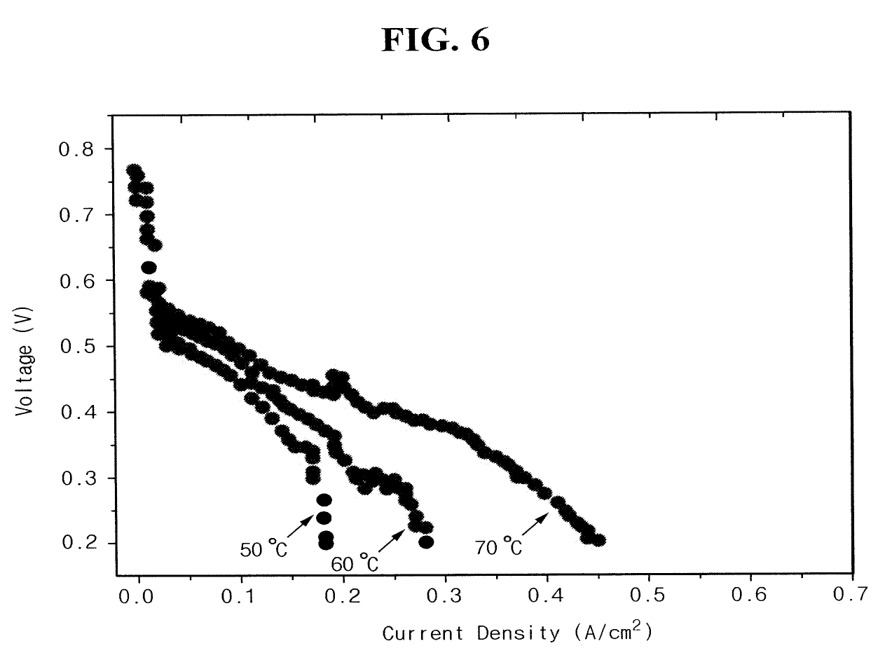

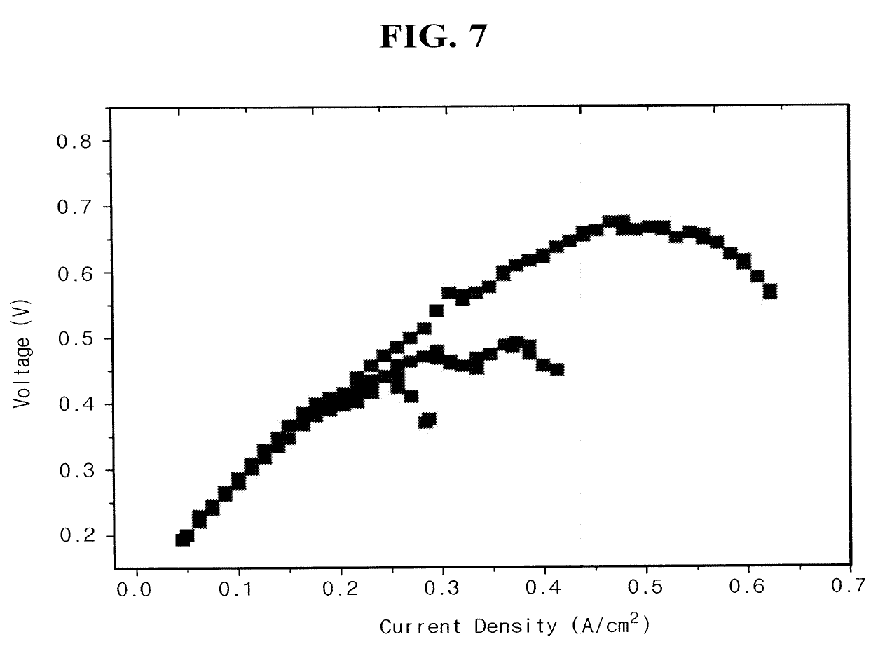

The unit cells fabricated according to Examples 1 to 5 and Comparative Example 1 were supplied with 1M of methanol and dry air and operated at 70° C. for 10 hours, and thereafter measured regarding power characteristics. The result of Example 1 is shown in FIGS. 4 and 5, and that of Comparative Example 1 is shown in FIGS. 6 and 7. Referring to the results, the unit cells of Example 1 turned out to have higher power density and current density at all temperatures, such as 50° C., 60° C., and 70° C. than that of Comparative Example 1.

In view of the foregoing, the membrane-electrode assembly for a fuel cell according to an embodiment of the present invention provides excellent reactant diffusion, and minimizes (or reduces) mass transfer resistance to thereby implement a relatively high power and/or a highly efficient fuel cell system.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A membrane-electrode assembly for a fuel cell, comprising:
a cathode;
an anode facing the cathode; and
a polymer electrolyte membrane between the cathode and the anode,
wherein at least one of the anode or the cathode comprises a plurality of channels disposed therein.

2. The membrane-electrode assembly of claim 1, wherein the channels of the at least one of the anode or the cathode extend in a reactant injection flow direction.

3. The membrane-electrode assembly of claim 1, wherein an average diameter of the channels ranges from about 10 nm to about 500 nm.

4. A method of manufacturing a membrane-electrode assembly for a fuel cell, the method comprising:
applying a material for reducing surface adherence on a releasing film including a plurality of first channels therein to form a surface adherence suppressing layer;
positioning the surface adherence suppressing layer with the releasing film on a plate for air suction;
applying a catalyst composition on the surface adherence suppressing layer while applying suction to form a catalyst layer comprising a plurality of second channels corresponding to the first channels;
positioning the releasing film with the catalyst layer on a polymer electrolyte membrane and transferring the catalyst layer to the polymer electrolyte membrane by hot-pressing; and
removing the releasing film with the surface adherence suppressing layer from the catalyst layer transferred to the polymer electrolyte membrane.

5. The method of claim 4, wherein the material for reducing surface adherence comprises a material selected from the group consisting of glycerine, polyethylene glycol, sorbitol, polytetramethylene glycol, siloxane, polypropyleneglycol, and combinations thereof.

6. The method of claim 5, wherein the releasing film comprises a material selected from the group consisting of polytetrafluoroethylene, polyvinylidene fluoride, polyethylene, polypropylene, polyethylene terephthalate, polyester, and combinations thereof.

7. A fuel cell system comprising:
an electricity generating element adopted to generate electricity through oxidation of a fuel and reduction of an oxidant, the electricity generating element comprising:
a membrane-electrode assembly comprising a cathode, an anode facing the cathode, and a polymer electrolyte membrane between the cathode and the anode, wherein at least one of the anode or the cathode comprises a plurality of channels disposed therein, and
a separator on a least one side of the membrane-electrode assembly;
a fuel supplier for supplying a fuel to the electricity generating element; and
an oxidant supplier for supplying an oxidant to the electricity generating element.

8. The fuel cell system of claim 7, wherein the channels of the at least one of the anode or the cathode extend in a reactant injection flow direction.

9. The fuel cell system of claim 7, wherein an average diameter of the channels ranges from about 10 nm to about 500 nm.

10. The fuel cell system of claim 7, wherein the fuel cell system is a direct oxidation fuel cell system.

11. The fuel cell system of claim 7, wherein the fuel is a hydrocarbon fuel.

12. The fuel cell system of claim 7, wherein the at least one of the anode or the cathode comprises a catalyst layer.

13. The fuel cell system of claim 12, wherein the channels pass through the catalyst layer.

14. The fuel cell system of claim 12, wherein the catalyst layer comprises a catalyst and a binder.

15. The fuel cell system of claim 14, wherein a hydrogen of a hydrogen ion conductive group of the binder has been substituted with Na, K, Li, Cs, or tetrabutylammonium.

16. The fuel cell system of claim 7, wherein the polymer electrolyte membrane comprises a hydrogen ion conductive polymer.

17. The fuel cell system of claim 7, wherein a hydrogen of a hydrogen ion conductive group of the polymer electrolyte membrane has been substituted with Na, K, Li, Cs, or tetrabutylammonium.
